(19) United States
(12) Patent Application Publication
(10) Pub. No.: US 2005/0036451 A1
(43) Pub. Date: Feb. 17, 2005

(54) Portable instrument to test fibre channel nodes installed in an aircraft

(76) Inventor: Samuel I. Green, St. Louis, MO (US)

Correspondence Address: HARNESS, DICKEY & PIERCE, P.L.C., P.O. BOX 828, BLOOMFIELD HILLS, MI, 48303, US

(21) Appl. No.: 10/639,214

(22) Filed: Aug. 12, 2003

(51) Int. Cl. H04L 12/26

(52) U.S. Cl. 370/242; 370/248

(57) ABSTRACT

The invention enables the nodes of a Fibre Channel network to be more quickly and easily tested in situ within an aircraft. A method to test the receive port of a Fibre Channel (or Gigabit Ethernet or InfiniBand or FireWire) network node with a stimulating signal that forces the observable output signal from the transmit port of the network node to change in an observable manner to indicate the functioning of the receive port.

### FIELD OF THE INVENTION

The present invention relates to the testing of network nodes which transmit continuously when disconnected from the network, and more particularly to the testing of Fibre Channel nodes installed on aircraft.

### BACKGROUND OF THE INVENTION

Fibre Channel networks provide a combination of a high degree of flexibility in network topologies and a high bandwidth data link. While Fibre Channel technology arose to satisfy the demand for high bandwidth, remote access to mass storage devices, recent advances in aerospace technology have attempted to leverage Fibre Channel technology to networking high bandwidth aerospace devices. In particular, the Boeing Corporation of Chicago, Ill. is meeting success in implementing Fibre Channel networks on board an F/A-18 Hornet fighter/attack aircraft.

Onboard the F/A-18 a pair of functionally redundant Fibre Channel networks provides links between the mission computers and various peripheral devices. In particular, these peripheral devices include the digital map, the forward looking infrared camera, the phased array radar, and the cockpit displays. Using the high bandwidth capability of the Fibre Channel networks, the computers and cockpit displays may access enormous quantities of real time data from the other devices.

Traditionally, command-response data buses linked some of these devices together. Since these prior art data buses were bandwidth limited, to about 1 megabit per second, comparatively little data could be accessed via the bus. Boeing implemented Fibre Channel networks on the F/A-18 to enable access by the crew and onboard mission computers to the voluminous real time data.

However, high bandwidth Fibre Channel networks may fail in a manner which creates ambiguity as to which element of the network caused the failure. If the user removes the wrong avionics package in a search for the failed node, time and effort are wasted while discovering the error, and a removed box must be replaced and returned for service at great expense, even if found to be healthy. Such unnecessary servicing is expensive and bothersome for a commercial Fibre Channel network. In a combat system, though, such unnecessary unavailability could compromise the success of mission objectives.

Accordingly, built in test equipment is included onboard the aircraft to detect failed links. Though, due to weight and space limitations the built in test equipment will typically not be extensive enough to indicate whether the fault is due to a failure of the optical fibers or one of the nodes. While the fibers may be tested by disconnecting the cables at each node and measuring the light transmitted through the fibers, the nodes pose more of a problem. Typically, testing the nodes, with the full capability test equipment currently available, requires the removal of the entire package containing the node from the aircraft and subsequent connection with test equipment at a remote facility.

However, because of the uncertainty of which node may have failed, the wrong node may be removed for test. Accordingly, time and resources are unnecessarily consumed. Thus the use of Fibre Channel technology onboard combat aircraft has accentuated a need for quick, portable, and inexpensive equipment to test Fibre Channel nodes in situ.

### SUMMARY OF THE INVENTION

In many applications, and particularly military systems, mission critical Fibre Channel nodes which have failed must be detected, identified, and restored to operation on a priority basis. Otherwise, while troubleshooting continues, the platform containing the failed node will be unavailable for either offensive or defensive missions.

Accordingly, the present invention provides a portable apparatus and method for quickly and inexpensively determining which node of a Fibre Channel network has failed. To make the determination, the instrument evaluates the transmitter output and the receiver input of the Fibre Channel node for proper operation when disconnected from the network. If the signal level is adequate and the initially expected transmit sequence is correct and of sufficient amplitude, the instrument then injects an appropriate minimum-amplitude code sequence into the receiver of the Fibre Channel node. The instrument then observes the transmitter for another expected response, thereby testing the receiver and other portions of the state machine of the node.

Briefly, the method of the present invention includes verifying that the transmitter of the suspect node is accurately generating the sequence it should generate (e.g. the NOS sequence). A second such sequence is then transmitted back to the receiver of the suspect node to simulate the presence of another node (which the node under test will expect to also be attempting to establish a link). Since the node under test should, upon detecting the sequence from the simulated node, transmit a different sequence (the LOS sequence), the method includes verifying that the node under test is accurately generating this different sequence. If the suspect node fails either test, the user knows that the suspect node has indeed failed. If the node passes both tests, then the user knows that the node is indeed functioning properly, and the problem lies elsewhere.

Accordingly, a first embodiment in accordance with the principles of the present invention provides a test device for testing a Fibre Channel (or Gigabit Ethernet or InfiniBand or FireWire) network node. The device includes a monitor, a waveform generator, and an indicator. The monitor monitors the network node for a first waveform sequence which is representative of an attempt to establish a link to another node. The monitor also determines whether the first waveform accurately represents the NOS primitive sequence and whether the transmitter signal level is sufficient. If the first waveform accurately represents the NOS primitive sequence, the waveform generator generates a second waveform, typically identical to the first waveform, which emulates an attempt to establish a link by a second node. Moreover, the monitor monitors for a third waveform which is representative of an off line primitive sequence (OLS) of the network node which the network node should generate if the network node correctly responded to the second waveform. If the network node accurately generated the third waveform, the monitor indicates that the network node is functioning properly.

A second preferred embodiment in accordance with the principles of the present invention provides a method for testing a Fibre Channel network node. In the method, the network node is monitored to determine if it is accurately generating a first coded electrical waveform which is representative of a link failure sequence of the network node. If the network node is accurately generating the first waveform then a second coded electrical waveform which is representative of a link failure sequence of the network node is transmitted to the network node. The network node is then monitored for a third coded electrical waveform which is representative of an off line sequence of the network node which the network node generates if it responds correctly to the second waveform. If the network node accurately generates the third waveform the functioning of the network node is then indicated.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a network in accordance with a preferred embodiment of the present invention implemented on a military aircraft;

FIG. 2A is a portion of the state transition diagram of a Fibre Channel node in accordance with the principles of the present invention; and

FIG. 2B is another portion of the state transition diagram of a Fibre Channel node in accordance with the principles of the present invention;

FIG. 3 is a block diagram of an instrument in accordance with the principles of the present invention;

FIG. 4 is a block diagram of an instrument in accordance with the principles of the present invention;

FIG. 5 is a flowchart of a method in accordance with the principles of the present invention; and

FIG. 6 is a block diagram of an instrument in accordance with the principles of the present invention.

### DETAILED DESCRIPTION OF THE PREFERRED EMBODIMENTS

The following description of the preferred embodiment(s) is merely exemplary in nature and is in no way intended to limit the invention, its application, or uses. In particular, while the present invention is described with reference to implementation on an aircraft, it will be appreciated that the invention is readily applicable to any form of mobile platform or other fixed (i.e. non-mobile) applications, where it is desirable to identify quickly and easily whether the nodes of a Fibre Channel network are operating correctly.

Fibre Channel networks, whether Arbitrated Loop or Fabric, consist of one or more point-to-point links between pairs of nodes. Each node includes a transmitter, a receiver, and a network interface controller (NIC). When built in test equipment indicates a failed Fibre Channel link, the prior art test equipment cannot ascertain the difference between a broken fiber, a connector problem, a failed power supply (external or internal), a failed transmitter, a failed receiver, a failed NIC, or other failures in the node such as a failed central processing unit. For Fibre Channel nodes installed on military aircraft, a healthy node which is inadvertently removed from the aircraft can not be re-installed on the aircraft without extensive depot level testing to confirm its health. Thus, the present invention provides an instrument and method to ascertain whether the failure exists within the node, or external thereto, without requiring removal of the node from the aircraft. Thus, the present invention provides a quicker and less expensive alternative to removal and testing at a remote maintenance depot.

When the input and output fibers (or other Fibre Channel compatible media) are removed from a Fibre Channel node, the node enters a Link Failure state LF2, assuming the node had been configured for a fabric network. A node programmed to operate only in fabric mode will enter and remain in this same state on application of power when a link is broken, as when disconnected by removal of input and output fiber connections. In the LF2 state, the node continuously transmits the Not Operational Sequence (NOS) primitive which is a repeating sequence of the 8B/10B encoded characters K28.5, D21.2, S31.5, and D05.2. Thus, the node transmitter is readily tested by connecting a receiver and deserializer to the node transmitter and checking this primitive sequence for reliable reception. The test receiver may incorporate an input attenuator or an adjustable signal level threshold so that there is assurance that the received input from the node transmitter exceeds the required minimum signal level.

Once the node transmitter is shown to operate satisfactorily, a transmitter in the tester will inject a NOS primitive sequence into the node receiver input at the minimum signal level. In proper operation, the node will transition from Link Failure state LF2 to Link Failure state LF1. In LF1 the node continuously transmits the Offline Sequence (OLS) primitive as contrasted with the NOS primitive transmitted in LF2. The OLS primitive is a repeating sequence of the 8B/10B encoded characters K28.5, D21.1, D10.4, and D21.2. Thus, the node receiver is readily tested by connecting a transmitter and serializer to the node receiver and checking the OLS primitive sequence for reliable reception. The test transmitter may incorporate an output attenuator so that there is assurance that the node receiver operates correctly even with the allowed minimum signal level.

The tester can check the full received 40-bit sequence at the 10B encoded level or the full 32-bit sequence after conversion to the 8B format. In the alternative, the tester can detect the comma (K28.5) and check only the first character by looking for the change between D21.2 and D21.1. Moreover, these tests may be performed using a Fibre Channel network interface controller (NIC) under processor control or with simpler dedicated circuitry. Note also that for a node programmed to operate in a Fibre Channel arbitrated loop network, the expected primitive transmissions include several versions of the LIP primitive sequence (which all begin with the encoded characters K28.5 and D21.0) and the Idle signal (encoded characters K28.5, D21.4, D21.5, and D21.5) respectively.

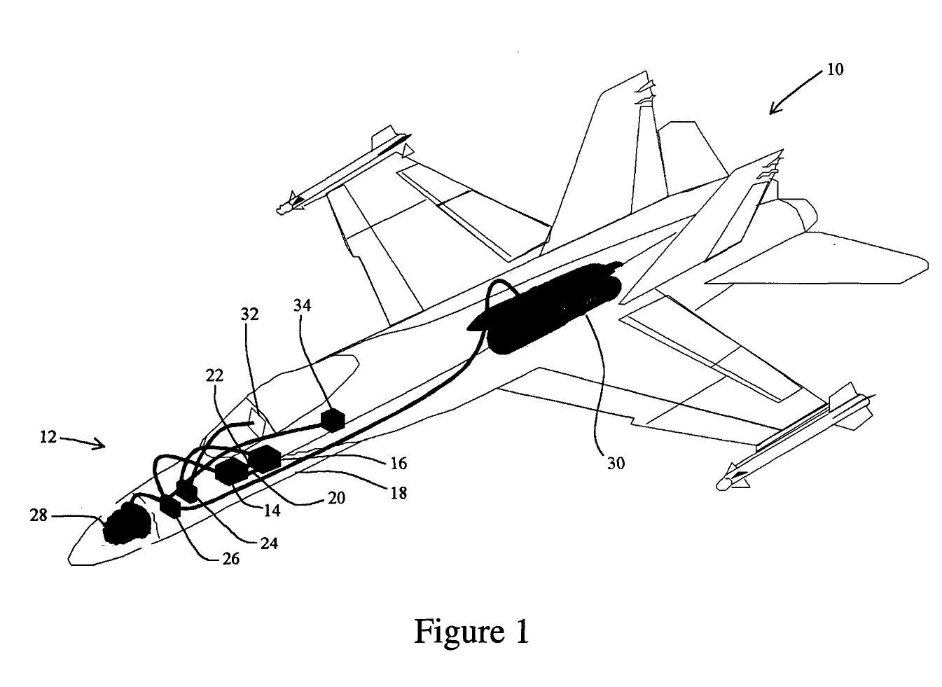

With reference now to FIG. 1, an F/A-18 aircraft is illustrated. The aircraft 10 includes a network 12 which includes a plurality of nodes. The network 12 may be a Fibre Channel network as shown or any network in which the nodes attempt to recover failed links by continuously transmitting even when the node detects a filed link. While, a successful recovery of the link will require the presence another functioning node on the network 12, each of the nodes will initiate the attempted recovery on their own initiative.

Within the network 12, a pair of redundant mission computers 14 and 16 may be linked via an arbitrated loop 18 consisting of a pair of Fibre Channel links 20 and 22. While the computers have been shown as linked in the arbitrated loop 18, the computers may be linked via another Fibre Channel topology (e.g. fabric). A pair of Fibre Channel switches, or fabrics 24 and 26, provide connectivity between the computers 14 and 16 and various peripheral devices via links between the individual fabrics 24 and 26 and the individual peripheral devices. The peripheral devices include the radar 28, the FLIR (Forward Looking Infrared) camera 30, the cockpit display 32, and the digital map 34.

As noted previously, if a link failure is detected the cause may be within either of the nodes connected to that link or the two cables of the link. While service personnel can readily test the optical fibers (or wires) by measuring light transmission (or electrical resistance) through the disconnected cable, the nodes generally require removal from the aircraft for testing with the full capability testers currently available. Such removal operations consume time and may result in the undesirable removal of a functioning node from the aircraft while the failed node remains to be examined in turn. Thus, service personnel greatly prefer an in-situ method of testing the installed nodes.

Traditionally, the computers and peripheral devices would have been connected on one or more redundant command-response data buses such as MIL-STD-1553 or SAE AS1773 buses. Test instruments for these types of data buses generally rely on the command-response nature of these buses to detect failed remote terminals. Generally these command-response test instruments simulate a command to the remote terminal which responds with a message containing data specified by the command. For instance U.S. Pat. No. 5,805,793 issued to Green describes various embodiments of command-response data bus testers and is incorporated as set forth in full herein.

Of course, any of the links or nodes of the network 12 (of FIG. 1) may fail, or be damaged, as with the command-response data buses described by the '793 patent. But one of the differences between the remote terminals of command-response data buses and nodes of a Fibre Channel network is that command-response remote terminals are totally inert unless commanded to respond by a real or simulated bus controller command as in '793-patent. Whereas Fibre Channel nodes transmit even when disconnected or isolated from the network, whether or not the receiver of the node has failed. Thus, a Fibre Channel node with a failed receiver will continue transmitting so that the transmit portion of a node may be readily analyzed.

Thus, continuously transmitting network nodes (e.g. Fibre Channel nodes), which are desirable for modern peripheral devices, behave differently than the bus controllers and remote terminals described by the '793 patent. Thus, while the instruments described therein reliably detect failures of command-response remote terminal devices, a similar need still exists to detect failures of the nodes of the network 12. Accordingly, the present invention provides an instrument, and a method, which exercises and tests the receiver and NIC functions of continuously transmitting nodes by simulating the signal from another node and examining the response.

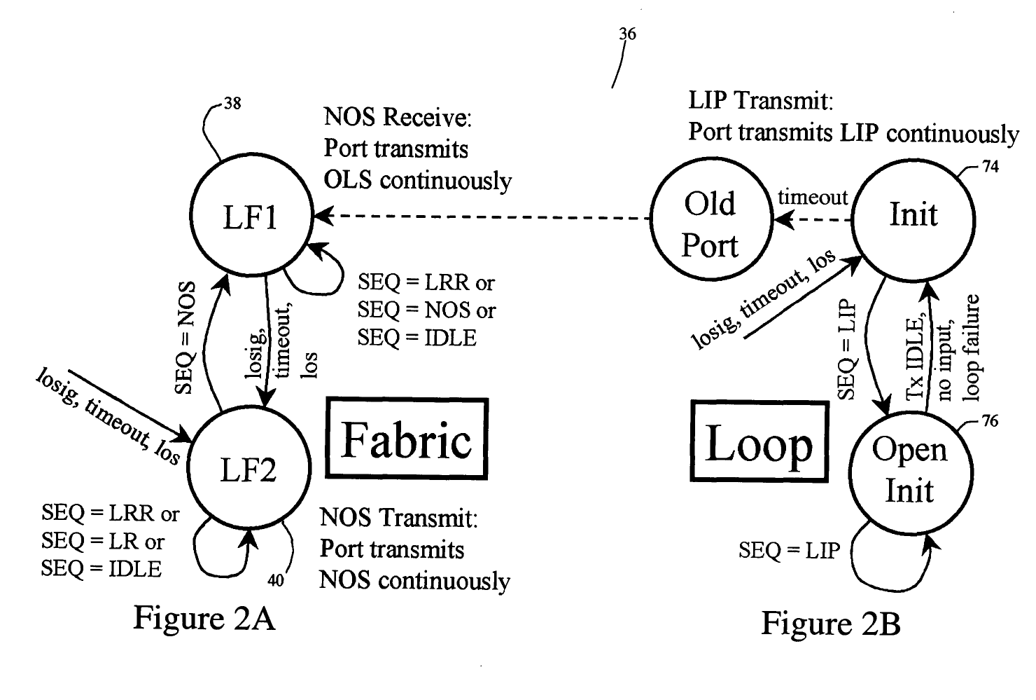

Many of these failures may cause the failed node to cease transmitting or receiving data. In the alternative, these failures may cause the node to cease transitioning between different states or a combination thereof. Should a particular node or link fail, the remaining nodes respond in accordance with the simplified state transition diagram 36 shown in FIGS. 2A and 2B.

FIG. 2A shows that the nodes installed in a Fibre Channel fabric network include at least two Link Failure states LF1 and LF2, 38 and 40 respectively. A node transitions to the LF2 (NOS Transmit) state upon sensing a link failure. Link failures may occur because of timeouts or loss of signal or low signal conditions. In the LF2 state, the node continuously transmits the NOS (not operational sequence) primitive sequence until it receives a NOS primitive sequence from an external source. When the node begins receiving the external NOS primitive sequence over the link, the node transitions to the LF1 (NOS Receive) state. While in the LF1 state, the node continuously transmits the OLS (offline sequence) primitive sequence. Thus, while a node requires another node to recover a link, each node initiates the recovery effort independently of the other nodes.

In summary, upon sensing a failed link, a node will begin transmitting the NOS primitive sequence. Upon sensing an external NOS primitive sequence, the node will begin transmitting the OLS primitive sequence.

The present invention takes advantage of the continuous transmission of the nodes to determine whether a node is functioning (e.g. transmitting, receiving, and transitioning between the LF1 and LF2 states). If the node is not functioning in this manner, then it is highly likely that the node has failed. Accordingly, replacing the now identified failed node enables repair with out unnecessary removals of functional hardware.

Now with reference to FIG. 2B similar node behavior may be seen for Fibre Channel nodes installed in an arbitrated loop (AL). If an arbitrated loop fails, an operating node transmits a Loop Initiate Primitive (LIP) sequence rather than the NOS primitive sequence of a fabric node. Receipt of an external LIP primitive sequence causes the node to transition from the Init (LIP Transmit) state 74 to the Open Init state 76. In the Open Init state 76, the node transmits an Idle primitive signal. Thus, in accordance with a preferred embodiment of the present invention an instrument is provided which monitors for the initial LIP primitive sequence, transmits a LIP primitive sequence, and then monitors for an Idle primitive signal.

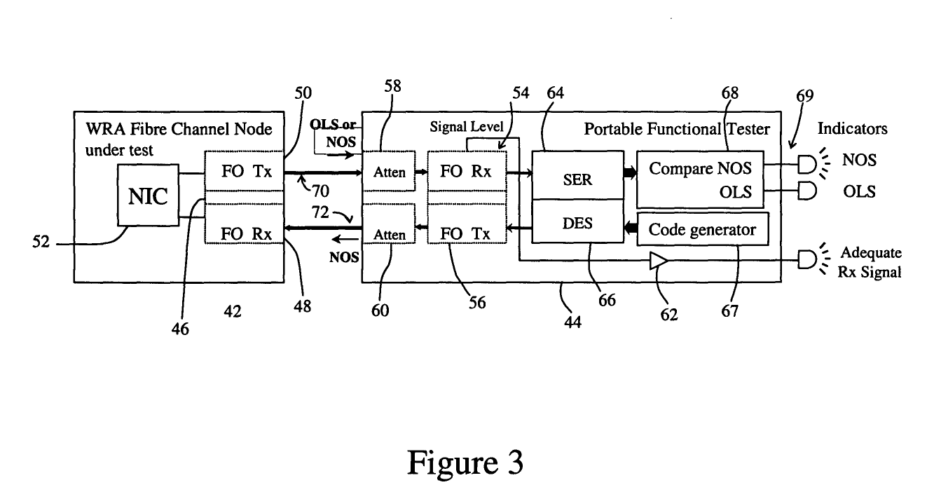

Turning now to FIG. 3, a node 42 and instrument 44 according to a preferred embodiment of the present invention may be seen. The node may be any Fibre Channel node and more particularly any Fibre Channel node still installed on an aircraft. Moreover, the node 42 may be either computer 14 or 16, the switches 24 or 26, the radar 28, the cockpit display 32, or the FLIR camera 30 (see also FIG. 1). As a Fibre Channel node, the node 42 includes at least one port 46 for connection to a pair of fibers. The port includes a facility 48 for receiving data from one fiber and one facility 50 for transmitting data over a second fiber. Of course the port may be any type of Fibre Channel port while the fiber may be any medium compatible with the Fibre Channel standard (e.g. fiber optic cables or pairs of twisted copper wires). The node typically includes a Fibre Channel NIC 52, or state machine, coupled to the nodes 48 and 50 such that the node 42 properly transitions between states and transmits/receives data accordingly.

The instrument 44, according to the present invention, also includes a pair of facilities 54 and 56 for receiving and transmitting data, a pair of signal attenuators 58 and 60, a signal comparator 62, a serializer 64, a deserializer 66, a primitive sequence comparator 68, and a set of indicators 69. Via the attenuators 58 and 60 respectively, the operator may adjust the strength of signals received by receiver 54 or transmitted by the transmitter 56. Thus, the signals may be more or less weakened to simulate minimum and maximum signal strength signals. The serializer 64 and deserializer 66 convert the transceived signals between serial and parallel format. Between the node 42 and instrument 44, a pair of optical fibers 70 and 72 link the node and the instrument. Alternatively, copper wires and electrical transmitters and receivers work similarly.

To use the instrument, the user disconnects the suspected node 42 from the network. The user accomplishes the disconnection by removing the network connector or via a break out box (not shown) while being able to leave the node 42 in the aircraft. As soon as the node 42 detects the loss of signal associated with the disconnection, the node 42 defaults to state LF2 (see FIG. 2). With the transition to LF2, the node begins transmitting the NOS primitive sequence via the node's transmitter 46 and the fiber 70. Accordingly, the instrument receiver 54 receives the signal as attenuated by the attenuator 58. Meanwhile the signal comparator 62 monitors the received signal and indicates via the indicators 69 whether the signal possesses sufficient amplitude.

At about the same time as the signal comparison, the serializer/deserializer 66 deserializes the received primitive sequence. Comparing the deserialized sequence to the NOS primitive sequence, the sequence comparator 68 determines whether the “as received” sequence matches the expected NOS primitive sequence. If the NOS sequence match fails, the instrument 44 may halt and declare the node 42 failed or may proceed as directed by the user.

Upon a successful NOS match accompanied by a sufficient signal level, the instrument automatically enables transmission of an NOS primitive sequence from a code generator 67 back to the node 42 via the instrument transmitter 56 and fiber 72. In the alternative, the instrument may signal the user that the node transmitter 50 and associated circuitry is functioning and then wait for a user input before transmitting the NOS primitive sequence back to the node 42. Note that the attenuator 60 may be used to set the amplitude of the transmitted signal to a level sufficient to meet the minimum and maximum permissible signal strengths.

If the node receiver 48 and NIC 52 operate correctly, receipt of the NOS sequence initiates a transition to state LF1. Within the LF1 state, the node 42 continuously transmits the OLS primitive sequence via the node transmitter 50 and fiber 70. Thus, after transmitting the NOS primitive sequence, the instrument 44 monitors the fiber 70 in expectation of receiving the OLS primitive sequence. As with the NOS primitive sequence from the node 42, the comparator 68 determines whether the as received primitive sequence matches the expected LOS primitive sequence. The comparator 68 then signals the success or failure of the comparison. Again, the signal comparator 62 may also indicate whether the signal complies with Fibre Channel signal level requirements.

Successful completion of the test set forth above includes the node 42 generating the initial NOS primitive sequence and generating the OLS primitive sequence following receipt of the instrument generated NOS primitive sequence. Successful completion of the test for a pre selected number of times (preferably more than one time) indicates that the node 42 is functioning properly. Likewise unsuccessful completion of the test indicates that the node 42 is faulty. Depending on the results, the user may then remove and replace the node 42.

In a preferred embodiment of the present invention, for use with Fibre Channel arbitrated loops, an instrument similar to instrument 44 is provided. The primary difference for the arbitrated loop instrument is that, whereas the instrument 44 compares the received sequences against the expected NOS and OLS primitive sequences, the current embodiment compares the received sequences to the LIP (loop initialization) primitive sequence and Idle primitive sequence, respectively. Also the present embodiment causes the node 42 to transition between the Init 74 and Open Init 76 states, as opposed to LF2 and LF1 respectively (see FIG. 2B). In other preferred embodiments the instrument 44 may be programmed into a field programmable gate array (FPGA) or implemented with a combination of a CPU and NIC with a related software program to execute the test.

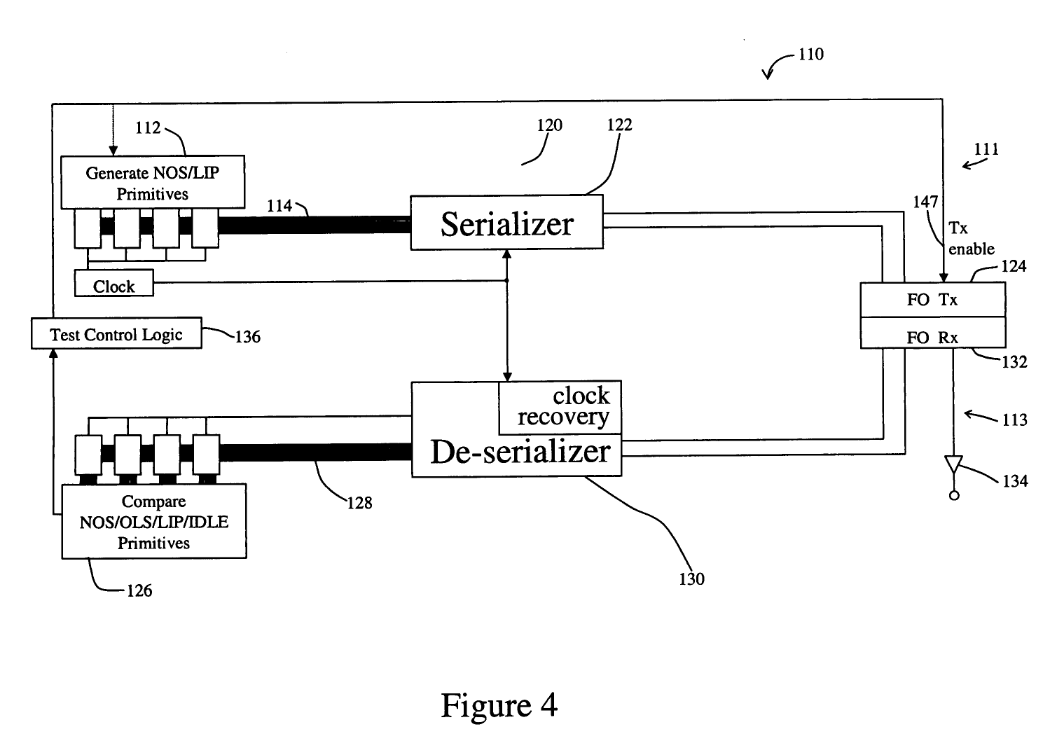

A preferred embodiment, all or portions of which may be programmed into a programmable circuit such as an FPGA, is shown in FIG. 4. An instrument 110 in accordance with the principles of this preferred embodiment generally includes a stimulate subsystem 111 and a monitor subsystem 113. Within the stimulate subsystem 111, the instrument 110 includes a waveform generator 112, a transmit data bus 114, a parallel to serial converter 122, and a fiber optic (or other Fibre Channel compatible media) transmitter 124. Within the monitor subsystem 113, the instrument 110 includes a fiber optic (or other Fibre Channel compatible) receiver 132, a deserializer 130, a received signal level comparator 134, a receiver data bus 128, and a sequence comparator 126. Between the two subsystems 111 and 113, the instrument 110 may include test control logic 136 to control transmit enable line 147. Those skilled in the art will recognize control and timing circuitry shown on FIG. 4, but not otherwise described herein, as not necessary to an understanding of the present invention. Accordingly, such unnecessary detail has been omitted for clarity.

In operation, a user disconnects the node to be tested from the Fibre Channel network (see for example the radar 28 shown in FIG. 1.) Otherwise, the user leaves the node installed in situ. In particular, the user leaves the node powered on during the test. The user then couples the node to the instrument at the transmitter 124 and receiver 132. Either the user may command the instrument 110 to begin monitoring for the NOS (or LIP) primitive sequence or the instrument may begin monitoring immediately.

Assuming that the node is continuously generating NOS primitive sequences, as it does when fully operational, the monitor subsystem 113 receives the signal (or waveform) at the receiver 132. The signal level comparator 134 verifies that the as received waveform meets the Fibre Channel standard for signal level. Depending on the results of the comparison, the comparator 134 may indicate whether the waveform, as an electromagnetic phenomenon, meets the Fibre Channel signal level requirements. Meanwhile, assuming that the waveform meets the signal level requirements, the deserializer 130 converts the serial data stream from the receiver 132 to a parallel representation of the received waveform and places the parallel sequence on the receiver data bus 128, as shown in FIG. 4. It should be noted that the waveforms described herein may be electromagnetic signals such as either optical signals or electrical signals when received at the receiver 132. Appropriate conversions may occur to enable the instrument 110 to read the data encoded in the waveform.

From the receiver data bus 128, the sequence comparator 126 reads the received sequence and compares it to the NOS (or LIP) primitive sequence. If the received primitive sequence matches the expected NOS (or LIP) primitive sequence (i.e. the received sequence is accurate), the comparator 126 indicates a successful test of the transmitter and sequence generation circuitry of the node transmitter. Note that the sequence comparator 126 may compare the as received primitive sequences to both the NOS and LIP primitive sequences. Depending on which primitive sequence it detects, the sequence comparator 126 may determine which type of Fibre Channel link (e.g. arbitrary loop or fabric) the node is attempting to recover.

Once the sequence comparator 126 detects an appropriate primitive sequence (e.g. the NOS or LIP primitive sequence), the sequence comparator 126 may signal the test control logic 136 to enable the transmitter 124 by asserting the Tx Enable control 147 thereby allowing transmitter 124 to transmit primitive sequences to the node. Asserting Tx Enable control 147 may also cause the waveform generator 112 to generate a NOS (or LIP) primitive sequence in parallel format. In the alternative, the waveform generator 112 may generate the primitive sequence continuously with the Tx Enable control 147 controlling when the primitive sequence is transmitted to the node.

The waveform generator 112 places the parallel NOS (or LIP) primitive sequence on the transmitter output port bus 114. From the transmitter data bus 114, the 10 bit register 116 temporarily stores the generated sequence. The multiplexer 120 reads the NOS primitive sequence from the transmitter output port bus 114. Then the multiplexer 120 passes the NOS primitive to the transmitter 124 which, if enabled, transmits the NOS (or LIP) primitive sequence to the node.

With continuing reference to FIG. 4, the serializer 122 converts the primitive data words from parallel to serial format. Now with the data words in serial format and encoded to simulate a Fibre Channel NOS (or LIP) sequence, the transmitter 124 transmits the NOS (or LIP) primitive sequence to the node under test when enabled at the appropriate time by the transmit enable control signal 147. At this time, the instrument 110 may begin a timer to determine how long it takes for the node to return an OLS primitive sequence (or Idle primitive signal). If the time exceeds a pre-selected value, the instrument 110 may indicate that the node has failed because of a timeout. Preferably the timer allows the node about 1000 milliseconds to return the expected primitive.

The instrument 110 tests the signal strength and compares the as received sequence with the expected OLS primitive sequence (or Idle primitive). At this point, the instrument 110 may repeat the test process. To do so, the instrument 110 may simulate a link failure (e.g. by intentionally not transmitting for the time necessary to cause the node to sense a timeout) and awaiting another initial NOS primitive sequence (or Idle primitive signal) from the node which should have transitioned to the LF2 state (or Init state).

In a preferred embodiment, a Gigabit Ethernet (GbE) transceiver chip such as one from the TLKxxxx family from Texas Instruments of Dallas, Tex. includes the parallel to serial converter 122 and the deserializer 130. The remaining logic shown in FIG. 4 is programmed into a field programmable gate array (FPGA) with appropriate connections made between the components on the GbE transceiver and the FPGA.

Thus, as can be seen with reference to FIGS. 3 and 4 in particular, the simple, stand alone, and portable test instrument 110 is provided to test a network node. Since the instrument 110 may be portable and light weight, the instrument is ideally suited for use at remote locations or in hostile environments (e.g. field maintenance sites or industrial control panels installed in manufacturing facilities). Moreover, because of the portable nature of the instrument 110 a user may respond quickly to detected failures without the need for sophisticated, expensive, and bulky test equipment. Namely neither full capability logic analyzers nor other functioning nodes need to be transported to the test site. Furthermore, because the instrument 110 may be implemented in less than a full computer, no software or associated storage devices need be employed. Likewise, the instrument 110 may power up without the need for time-consuming boot procedures. The latter benefit of the present invention allows the service person to respond readily to crises.

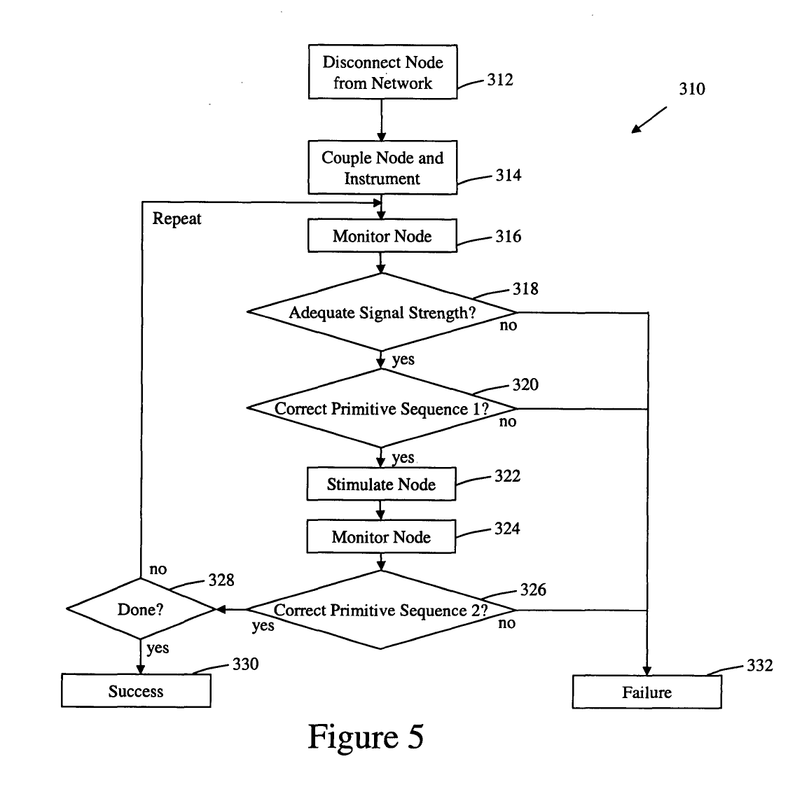

Turning now to FIG. 5, a flowchart of a method in accordance with a preferred implementation of the present invention may be seen. Generally, the method includes monitoring the transmission of the expected Fibre Channel primitive sequences and determining if the transmission is of sufficient signal strength and accuracy. The foregoing tests the transmitter of the node and the transmit portion of the NIC. Then the receiver of the node is tested by sending to it a minimum amplitude primitive sequence which is expected to cause a change in the transmitted sequence as an acknowledgement. Retest and observation continues to determine whether the expected response occurs repeatedly and reliably. Failure of either the transmitter or receiver tests indicates a problem with the installed node.

To begin the method 310, the node to be tested is disconnected from the network in which it normally resides. The node is left powered on or turned on if not already powered. See step 312. Since the instruments provided by the present invention are portable and simple, no need exists to also remove the node from its installed location. An instrument may then be coupled to the port of the node as in step 314. Meanwhile, the disconnected, but powered, node should have transitioned to a state in which it ought to be transmitting a primitive sequence indicating that it has detected a link failure and is trying to establish a link to another node. For Fibre Channel devices, these sequences include the NOS and LIP primitive sequences.

The user thus monitors the node for a period of time to observe transmission of a primitive a sequence indicative of the node's detection of a link failure. Notably, the node should be transmitting NOS or LIP primitive sequences continuously. If a pre-selected timeout period expires before the node transmits the initial primitive sequence, a failure may be declared. See step 316. Also, the signal is verified as accurately complying with Fibre Channel standards for signal level and accuracy. If the signal is not of proper amplitude, a failure of the unit may be declared as steps 318 and 319 illustrate.

Otherwise, the test may continue with step 320. In step 320 the as received primitive sequence is compared to an expected primitive sequence for this, the initial sequence. Here, the expected primitive sequence is either a NOS or LIP primitive sequence, depending on the network topology. If an incorrect (i.e. inaccurate) primitive sequence is detected in any of several tries, then the node may be declared to be malfunctioning as steps 320 and 319 illustrate. Otherwise, the test continues.

Next, and notably after the monitoring for the initial primitive sequence in step 316, the node is stimulated with a primitive sequence which the node would expect to receive should another node be attempting to establish or recover the failed link. Here a NOS or LIP primitive sequence is transmitted to stimulate the node by emulating another node attempting to establish or recover the link. See step 322.

Monitoring of the node continues as in step 324 to determine if the node responds to the stimulation. If, within a pre-selected time, the node has not responded with a changed primitive sequence indicating that it has responded to the stimulus, the node may be declared to be failed. See step 326. In the alternative, the test of the node may repeat while statistics are gathered on the pass/fail rate of the node. If, in contrast, the node responds by transmitting such a primitive sequence or signal (the OLS sequence or Idle primitive), the test may continue to step 328. Of course, since the signal amplitude has already been verified as complying with Fibre Channel standards, (in step 318) the re-verification of the signal levels may be omitted.

If further assurance is required that the node is healthy, the test may repeat steps 316 to 326 for a pre-selected number of times before declaring the test successful (i.e. the node is operating correctly). Other alternative embodiments of the method allow the node a pre-selected number of incorrect transmissions in steps 320 or 326 or a pre selected number of inaccurate signals in step 318 before a failure is declared. Thus, occasional failures may be permitted depending upon the application.

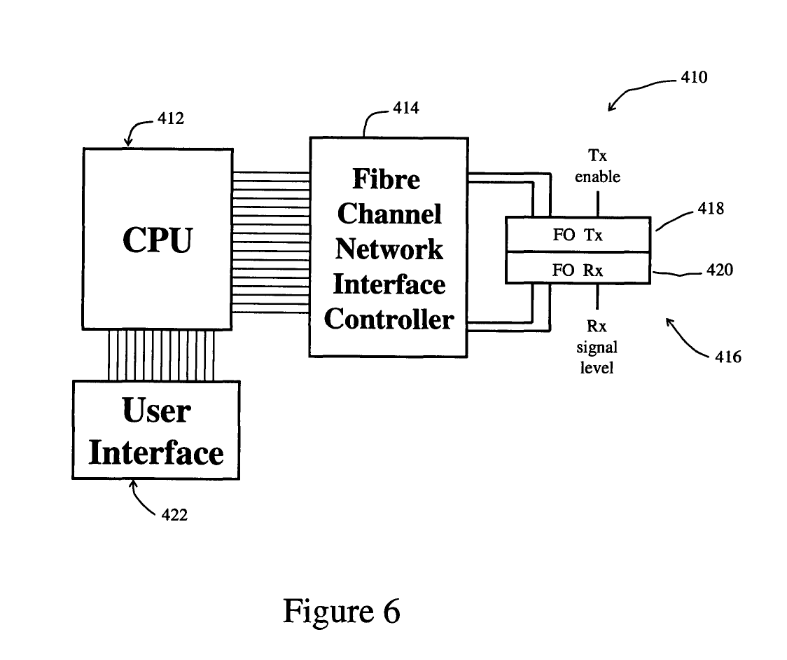

Turning now to FIG. 6, a preferred embodiment which may be implemented with a CPU and NIC may be seen. An instrument 410 includes a CPU 412, a Fibre Channel NIC 414, and a port 416 including a transmitter 418, a receiver 420, and a user interface 422. Generally, the CPU 412 may execute an application program or instruction set to perform a method similar to the method 310. An alternative embodiment replaces the CPU with an ASIC or other programmable chip.

The CPU 412 programs the NIC 414 as a fabric or loop node. Additionally, the port 416 provides the receiver 420 and the transmitter 418 with which the instrument 410 communicates with the node under test. For the user, the user interface 422 accepts user input and displays the results of the test of the node and may constitute a graphic user interface (GUI) for controlling the instrument 410. When the receiver 420 receives a Fibre Channel primitive sequence (or signal) the NIC 414 recognizes this information and attempts to establish a link and reports success or failure to the CPU 412. The CPU 412 may display the results of the test on the display 422.

As those skilled in the art will appreciate, the present invention provides a simple, inexpensive, stand alone test instrument for determining whether a network node has failed. Accordingly node and network downtime may be greatly reduced thereby providing more reliability to the user and the system (e.g. aircraft) in which the network is imbedded.

The description of the invention is merely exemplary in nature and, thus, variations that do not depart from the gist of the invention are intended to be within the scope of the invention. Such variations are not to be regarded as a departure from the spirit and scope of the invention.

1. A stand-alone, non-computer-controlled test device for testing a network node, comprising:
an electrical monitor for monitoring a first coded electromagnetic waveform which is representative of a link failure sequence of the network node and determining whether the first waveform accurately represents the link failure sequence;
an electrical waveform generator for generating a second coded electromagnetic waveform which is representative of the link failure sequence of the network node;
the monitor further operating to monitoring a third coded electromagnetic waveform which is representative of an off line sequence of the network node which the network node generates if the second waveform as successfully received by the network node accurately represented the link failure sequence; and
an indicator to notify whether the network node generated the third waveform, so that proper functioning of the network node is determined.

2. The test device according to claim 1, wherein the network comprises a Fibre Channel network.

3. The test device according to claim 2, wherein a topology of the network comprises an arbitrated loop.

4. The test device according to claim 2, wherein a topology of the network comprises a fabric.

5. The test device according to claim 1, wherein the signals are conveyed between nodes by optical fibers.

6. The test device according to claim 1, wherein the signals are conveyed between nodes by electrically conductive wires.

7. The test device according to claim 1, further comprising a waveform comparator for determining whether an electromagnetic signal of the first coded electromagnetic waveform is accurate.

8. The test device according to claim 1, further comprising a programmable logic device.

9. The test device according to claim 1, wherein the link failure sequence comprises a not operational primitive sequence.

10. The test device according to claim 1, wherein the link failure sequence comprises a link initialization primitive sequence.

11. A method of testing a network node which transmits continuously when disconnected from the network, comprising:
monitoring for a first coded electromagnetic waveform which is representative of a link failure sequence of the network node;
determining whether the first waveform accurately represents the link failure sequence;
generating a second coded electromagnetic waveform which is representative of a link failure sequence of the network node if the first waveform accurately represented the link failure sequence;
monitoring for a third coded electromagnetic waveform which is representative of an off line sequence of the network node which the network node is to generate if the second waveform as received by the network node accurately represents the link failure sequence; and
indicating whether the network node generated the third waveform, whereby proper functioning of the network node including a receive portion of the network node is determined.

12. The method according to claim 11, wherein the testing of the network node comprises testing of a Fibre Channel network node.

13. The method according to claim 12, wherein the testing of the network node comprises testing a network node in a state associated with an arbitrated loop.

14. The method according to claim 12, wherein the testing of the network node comprises testing a network node in a state associated with a network fabric.

15. The method according to claim 11, wherein the testing of the network node comprises testing a fiber optic port.

16. The method according to claim 11, wherein the testing of the network node comprises testing an electrical port.

17. The method according to claim 11, wherein the testing of the network node comprises comparing an electromagnetic signal of the first coded electromagnetic waveform to an expected signal.

18. The method according to claim 11, wherein the testing of the network node comprises using a programmable device.

19. The method according to claim 11, wherein the testing of the network node comprises the link failure sequence being a not operational primitive sequence.

20. The method according to claim 11, wherein the testing of the network node comprises the link failure sequence being a link initialization primitive sequence.
